(19) United States
(12) Patent Application Publication
(10) Pub. No.: US 2013/0028325 A1
(43) Pub. Date: Jan. 31, 2013

(54) Method and device for error concealment in motion estimation of video data

(71) Applicants: HERVÉ LE FLOCH, Rennes (FR); Naël OUEDRAOGO, Maure de Bretagne (FR)

(72) Inventors: HERVÉ LE FLOCH, Rennes (FR); Naël OUEDRAOGO, Maure de Bretagne (FR)

(73) Assignee: CANON KABUSHIKI KAISHA, Tokyo (JP)

(21) Appl. No.: 13/560,800

(22) Filed: Jul. 27, 2012

(30) Foreign Application Priority Data
Jul. 29, 2011 (GB) 1113113.3

(51) Int. Cl. H04N 7/32

(52) U.S. Cl. 375/240.16; 375/E07.105

(57) ABSTRACT

An encoder extracts motion vectors from a frame I(t−1) preceding the frame I(t) being encoded, to create a motion complexity map and creating an irregular grid of cells, the sizes of the cells based on the complexity of motion in the frame at a respective position. This gives a motion vector field made up of an irregular grid of differently-sized cells, each cell having associated with it a motion vector. The motion vectors are transmitted to the decoder as auxiliary information along with the usual motion prediction information. The decoder receives the motion prediction information, with a slice missing, and the auxiliary information. The decoder rebuilds the irregular grid for frame I(t) based on the frame I(t−1) similarly, and fills the cells with the motion vectors from the auxiliary information, thus recreating an estimated motion vector field for the current frame I(t) for subsequent error concealment/decoding/displaying.

### CROSS-REFERENCE TO RELATED APPLICATIONS

This application claims the benefit under 35 U.S.C. §119(a)-(d) of UK Patent Application No. 1113113.3, filed on Jul. 29, 2011 and entitled “Method and Device for Error Concealment in Motion Estimation of Video Data”.

The above cited patent application is incorporated herein by reference in its entirety.

### FIELD OF THE INVENTION

The present invention relates to video data encoding and decoding. In particular, the present invention relates to video encoding and decoding using an encoder and a decoder such as those that use the H.264/AVC standard encoding and decoding methods. The present invention focuses on error concealment based on motion information in the case of part of the video data being lost between the encoding and decoding processes.

H.264/AVC (Advanced Video Coding) is a standard for video compression that provides good video quality at a relatively low bit rate. It is a block-oriented compression standard using motion-compensation algorithms. By block-oriented, what is meant is that the compression is carried out on video data that has effectively been divided into blocks, where a plurality of blocks usually makes up a video frame (also known as a video picture). Processing frames block-by-block is generally more efficient than processing frames pixel-by-pixel and block size may be changed depending on the precision of the processing. A large block (or a block that contains several other blocks) may be known as a macroblock and may, for example, be 16 by 16 pixels in size. The compression method uses algorithms to describe video data in terms of a movement or translation of video data from a reference frame to a current frame (i.e. for motion compensation within the video data). This is known as “inter-coding” because of the inter-image comparison between blocks. The following steps illustrate the main steps of the ‘inter-coding’ applied to the current frame at the encoder side. In this case, the comparison between blocks gives rise to information (i.e. a prediction) regarding how an image in the frame has moved and the relative movement plus a quantized prediction error are encoded and transmitted to the decoder. Thus, the present type of inter-coding is known as “motion prediction encoding”.

1. A current frame is to be a “predicted frame”. Each block of this predicted frame is compared with a reference areas in a reference frame to give rise to a motion vector for each predicted block pointing back to a reference area. The set of motion vectors for the predicted frame obtained by this motion estimation gives rise to a motion vector field. This motion vector field is then entropy encoded.

2. The current frame is then predicted from the reference frame and the difference signal for each predicted block with respect to its reference area (pointed to by the relevant motion vector) is calculated. This difference signal is known as a “residual”. The residual representing the current block then undergo a transform such as a discrete cosine transform (DCT), quantisation and entropy encoding before being transmitted to the decoder.

Defining a current block by way of a motion vector from a reference area (i.e. by way of temporal prediction) will, in many cases, use less data than intra-coding the current block completely without the use of motion prediction. In the case of intra-coding a current block, that block is intra-predicted (predicted from pixels in the neighbourhood of the block), DCT transformed, quantized and entropy encoded. Generally, this occurs in a loop so that each block undergoes each step above individually, rather than in batches of blocks, for instance. With a lack of motion prediction, more information is transmitted to the decoder for intra-encoded blocks than for inter-coded blocks.

Returning to inter-coding, a step which has a bearing on the efficiency and efficacy of the motion prediction is the partitioning of the predicted frame into blocks. Typically, macroblock-sized blocks are used. However, a further partitioning step is possible, which divides macroblocks into rectangular partitions with different sizes. This has the aim of optimising the prediction of the data in each macroblock. These rectangular partitions each undergo a motion compensated temporal prediction.

The inter-coded and intra-coded partitions are then sent as an encoded bitstream through a communication channel to a decoder.

At the decoder side, the inverse of the encoding processes is performed. Thus, the encoded blocks undergo entropy decoding, inverse quantisation and inverse DCT. If the blocks are intra-coded, this gives rise to the reconstructed video signal. If the blocks are inter-coded, after entropy decoding, both the motion vectors and the residuals are decoded. A motion compensation process is conducted using the motion vectors to reconstruct an estimated version of the blocks. The reconstructed residual is added to the estimated reconstructed block to give rise to the final version of the reconstructed block.

Sometimes, for example, if the communication channel is unreliable, packets being sent over the channel may be corrupted or even lost. To deal with this problem at the decoder end, error concealment methods are known which help to rebuild the image blocks corresponding to the lost packets.

There are two main types of error concealment: spatial error concealment and temporal error concealment.

Spatial error concealment uses data from the same frame to reconstruct the content of lost blocks from that frame. For example, the available data is decoded and the lost area is reconstructed by luminance and chrominance interpolation from the successfully decoded data in the spatial neighbourhood of the lost area. Spatial error concealment is generally used in a case in which it is known that motion or luminance correlation between the predicted frame and the previous frame is low, for example, in the case of a scene change. The main problems with spatial error concealment is that the reconstructed areas are blurred because the interpolation can be considered to be equivalent to a kind of low-pass filtering of the image signal of the spatial neighbourhood; and this method does not deal well with a case in which several blocks—or even a whole slice—are lost.

Temporal error concealment—such as that described in US 2009/0138773, US 2010/0309982 or US 2010/0303154—reconstructs a field of motion vectors from the data available and then applies a reconstructed motion vector corresponding to a lost block in a predicted frame in such a way as to enable prediction of the luminance and the chrominance of the lost block from the luminance and chrominance of the corresponding reference area in the reference frame. For example, if the motion vector of a predicted block in a current predicted frame has been corrupted, a motion vector can be computed from the motion vectors of the blocks located in the spatial neighbourhood of the predicted block. This computed motion vector is then used to recognise a candidate reference area from which the luminance of the lost block of the predicted frame can be estimated. Temporal error concealment works if there is sufficient correlation between the current frame and the previous frame (used as the reference frame), for example, when there is no change of scene.

However, temporal error concealment is not always effective when several blocks or even full slices are corrupted or lost.

It is desirable to improve the motion reconstruction process in video error concealment while maintaining a high decoding speed and high compression efficacy. Specifically, it is desirable to improve the block reconstruction quality while transmitting a very low quantity of auxiliary information and limiting delay in transmission.

Video data that is transmitted between a server (acting as an encoder) and at least one client (acting as a decoder) over a packet network is subject to packet losses (i.e. losses of packets that contain the elementary video data stream corresponding to frame blocks). For example, the network can be an internet protocol (IP) network carrying IP packets. The network can be a wired network and/or a wireless network. The network is subject to packet losses at several places within the network. Two kinds of packet losses exist:
Losses due to the congestion of the network. In such a case, the quantity of data sent is too high and at least one router of the network drops a percentage of the received packets.
Losses due to interference. As an example, these interferences can occur over a wireless network due to parasite micro-waves.

For dealing with these losses, several solutions are possible. The first solution is the usage of a congestion control algorithm. If loss notifications are received by the server (i.e. notifications that packets are not being received by the client), it can decide to decrease its transmission rate, thus controlling congestion over the network. Congestion control algorithms like TCP (Transmission Control Protocol) or TFRC (TCP Friendly Rate Control) implement this strategy. However, such protocols are not fully effective for facing congestion losses and are not at all effective for facing interferences losses.

Other solutions are based on protection mechanisms.

Forward Error Code (FEC) protects transmitted packets (e.g. RFC 2733) by transmitting additional packets with the video data. However, these additional packets can take up a large proportion of the communication channel between the server and the client, risking further congestion. Nevertheless, FEC enables the reconstruction of a perfect bit-stream if the quantity of auxiliary information is sufficient.

Packet retransmission (e.g. RFC 793), as the name suggests, retransmits at least packets that are lost. This causes additional delay that can be unpleasant for the user (e.g. in the context of video conferencing, where a time lag is detrimental to the efficient interaction between conference attendees). The counterpart of this increased delay is a very good reconstruction quality.

The use of redundant slices (as discussed in “Systematic Lossy Error Protection based on H.264/AVC redundant slices and flexible macroblock ordering”, Journal of Zhejiang University, University Press, co-published with Springer, ISSN1673-565X (Print) 1862-1775 (Online), Volume 7, No. 5, May 2006) requires the transmission of a high quantity of auxiliary information (though this quantity is usually lower than the quantity generated by the FEC). Redundant slices often enable only an approximation of the lost part of the video data.

As mentioned above, spatial and temporal error concealment work well if only a very small number of packets are lost, and if the packets that are lost contain blocks that are not near each other either spatially or temporally respectively because it is the neighbouring blocks (in the spatial or temporal direction) that are used to rebuild the lost blocks.

Thus, none of the solutions proposed in the prior art enables the improvement of the block reconstruction quality while transmitting a very low quantity of auxiliary information and limiting delay in transmission.

It is thus proposed to improve the quality of the lost blocks of the video (using error concealment algorithms) while transmitting little auxiliary information. This will be described below with reference to the figures.

### SUMMARY OF THE INVENTION

According to a first aspect of the invention, there is provided an encoder for encoding a first frame I(t) of a video bitstream, the first frame being defined by a plurality of blocks of pixels, the encoder comprising: means for generating an irregular grid of cells, each cell having a size generated according to a motion vector field derived from motion information of a second frame I(t−1) of the video bitstream; means for generating motion vectors to be applied to each cell of the irregular grid, the generated motion vectors being representative of the motion in the first frame I(t) of the video bitstream; and means for transmitting the generated motion vectors to a decoder.

The complexity (or extent) of motion demonstrated by the motion vector field in the second frame is preferably determined by comparison with a preceding frame I(t−2) and gives rise to a complexity map. This complexity map gives an indication of areas of high complexity and areas of low complexity. Blocks of pixels in areas of low complexity are grouped together in large cells with one motion vector allocated to it (ways of determining the motion vector to be allocated to it are described below and may involve more than simply taking an average of the motion vectors of the blocks in the large cell) and blocks in areas are high complexity are divided (or grouped) into small cells. The sizes of the large and small cells are variable and may be anything from a block to the whole frame, the latter being possible if there is substantially no movement from one frame to the next. Once the cell sizes are determined, this gives rise to an “irregular grid” representing the second frame, as the grid cells are chosen based on the motion of the second frame. Motion vectors of the first frame (i.e. the frame being encoded) are then mapped onto the irregular grid using methods described below.

According to a second aspect of the invention, there is provided a transcoder for encoding a first frame I(t) of a video bitstream, the first frame being defined by a plurality of blocks of pixels, the encoder comprising: means for generating an irregular grid of cells, each cell having a size generated according to a motion vector field derived from motion information of a second frame I(t−1) of the video bitstream; means for generating motion vectors to be applied to each cell of the irregular grid, the generated motion vectors being representative of the motion in the first frame I(t) of the video bitstream; and means for transmitting the generated motion vectors to a decoder. A transcoder is similar in function to an encoder, but creates decoding information (e.g. as auxiliary information) from video data that has already been encoded, rather than from raw data as the encoder does.

According to a third aspect of the invention, there is provided a device—optionally an encoder—for generating auxiliary information for a first frame I(t) of a video bitstream, the first frame being defined by a plurality of blocks of pixels, the encoder comprising: means for generating an irregular grid of cells for the frame I(t) based on the motion information of a second frame I(t−1) of the video bitstream; means for generating motion vectors to be applied to each cell of the irregular grid, the generated motion vectors representing the motion of the first frame I(t) of the video bitstream; and means for transmitting the generated motion vectors to a decoder as auxiliary information.

According to a fourth aspect of the invention, there is provided a decoder for decoding a first frame I(t) of a video bitstream, the decoder comprising: means for generating an irregular grid of cells, each cell having a size generated according to a complexity of a motion vector field based on motion information of a second frame I(t−1) of the video bitstream at the respective position of the cell; means for receiving motion vectors from an encoder to be applied to each cell of the irregular grid, the received motion vectors representing the motion of the first frame I(t) of the video bitstream at the position of the cell; and means for applying the received motion vectors to the cells of the generated irregular grid to generate a motion vector field to be used for motion prediction of the first frame I(t).

The present invention is applicable where the first frame I(t) has lost one or more blocks of pixels while being transmitted from the encoder to the decoder. The decoder does not receive the irregular grid from the encoder, but recreates it itself using motion information from the preceding frames I(t−1), etc. The decoder does receive the motion vectors from the encoder that correspond to the first frame I(t) but that are associated with the cells in the irregular grid. In this way, the decoder determines which cells of the irregular grid correspond to or contain missing blocks and applies the received motion vectors of those cells to the incomplete first frame I(t) at the respective cell position. The advantage of this is that only the motion vectors need to be transmitted: both the encoder and the decoder are able to recreate the same irregular grid using correctly-received frames and certain predetermined rules.

According to a fifth aspect of the present invention, there is provided a processing device for generating an irregular grid of cells, each cell having associated with it a separate motion vector based on the motion in a current frame I(t−1) of a video bitstream, the processing device comprising: means for reading a plurality of blocks of the current frame I(t−1); means for determining a complexity value representing the complexity of motion within each block of the current frame I(t−1); means for grouping blocks together that have a low complexity value into a large cell with a single motion vector representing motion within the large cell, and for grouping or dividing blocks that have a high complexity value into small cells, each small cell having a motion vector representing the motion within each small cell; and means for generating an irregular grid made up of the large and/or small cells. This same processing device may be present in either or both of the encoder and the decoder, or indeed in a transcoder, which, as mentioned above, creates the estimated motion vector information that is sent to the decoder based on already-encoded video data rather than on raw data.

According to a sixth aspect of the present invention, there is provided an image processing system comprising an encoder as described above and a decoder as described above, wherein the encoder and the decoder are configured to generate the same irregular grid of cells.

According to a seventh aspect of the present invention, there is provided an encoding method of encoding a first frame I(t) of a video bitstream, the method comprising: generating an irregular grid of cells, each cell having associated with it a separate motion vector based on the motion of a second frame I(t−1) of the video bitstream at the position of the respective cell; generating motion vectors to be applied to each cell of the irregular grid, the generated motion vectors representing the motion of the first frame I(t) of the video bitstream at positions corresponding to the positions of each cell when the irregular grid is applied to the first frame I(t); and transmitting the generated motion vectors to a decoder.

According to an eighth aspect of the present invention, there is provided a decoding method of decoding a first frame I(t) of a video bitstream, the method comprising: generating an irregular grid of cells, each cell having associated with it a motion vector based on the motion of a second frame I(t−1) of the video bitstream at the position of the respective cell; receiving motion vectors from an encoder to be applied to each cell of the irregular grid, the generated motion vectors representing motion in the first frame I(t) at positions corresponding to positions of the cells of the irregular grid when applied to the first frame I(t); and applying the received motion vectors to the cells of the generated irregular grid to generate a motion vector field to be used for motion prediction of the first frame I(t).

According to a ninth aspect of the present invention, there is provided a transcoding method comprising: generating an irregular grid of cells, each cell having associated with it a separate motion vector based on the motion of a second frame I(t−1) of the video bitstream at the position of the respective cell; generating motion vectors to be applied to each cell of the irregular grid, the generated motion vectors representing the motion of the first frame I(t) of the video bitstream at positions corresponding to the positions of each cell when the irregular grid is applied to the first frame I(t); and transmitting the generated motion vectors to a decoder.

According to a tenth aspect of the present invention, there is provided a method of generating an irregular grid of cells, each cell having associated with it a motion vector based on the motion of a current frame I(t−1) of a video bitstream, the method comprising: reading a plurality of blocks of the current frame; determining a complexity value representing the complexity of motion within each block of pixels of the current frame; grouping blocks together that have a low complexity value into a large cell with a single motion vector representing the motion within the large cell, and grouping or dividing blocks that have a high complexity value into small cells, each having motion vectors representing the motion within each small cell; and generating an irregular grid made up of the large and/or small cells.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

### BRIEF DESCRIPTION OF THE DRAWINGS

FIG. 1 depicts an overview of a video communication system usable with the present invention;

FIG. 2 depicts the architecture of an encoder/decoder system usable with the present invention;

FIG. 3 illustrates a motion estimation process of a video encoder;

FIGS. 4A and 4B illustrate the main steps for extracting the motion auxiliary information according to embodiments of the present invention;

FIG. 5 illustrates a motion sub-sampling process according to an embodiment of the present invention;

FIG. 6 illustrates the creation of an irregular grid used for calculating the motion information (auxiliary information);

FIG. 7 illustrates how motion vectors (as auxiliary information) are calculated according to an embodiment of the present invention;

FIG. 8 illustrates how to predict a motion vector field for a frame at time ‘t’ based on the encoded frame at time ‘t−1’ according to an embodiment of the present invention;

FIG. 9 illustrates how the auxiliary information is used by the video decoder for reconstructing the lost slices according to an embodiment of the present invention; and

FIG. 10 illustrates a device implementing a method of processing a coded data stream in accordance with an embodiment of the invention.

### DETAILED DESCRIPTION OF THE PREFERRED EMBODIMENTS

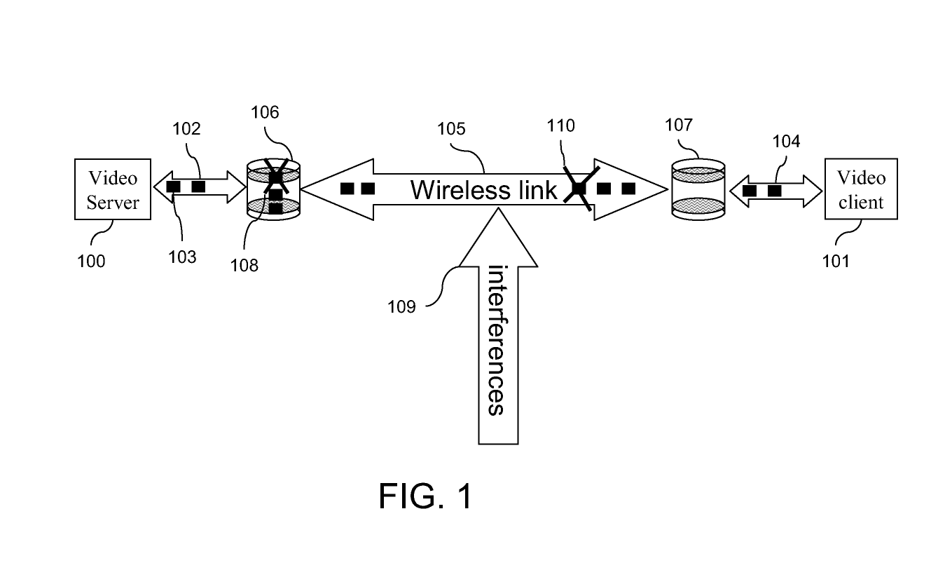

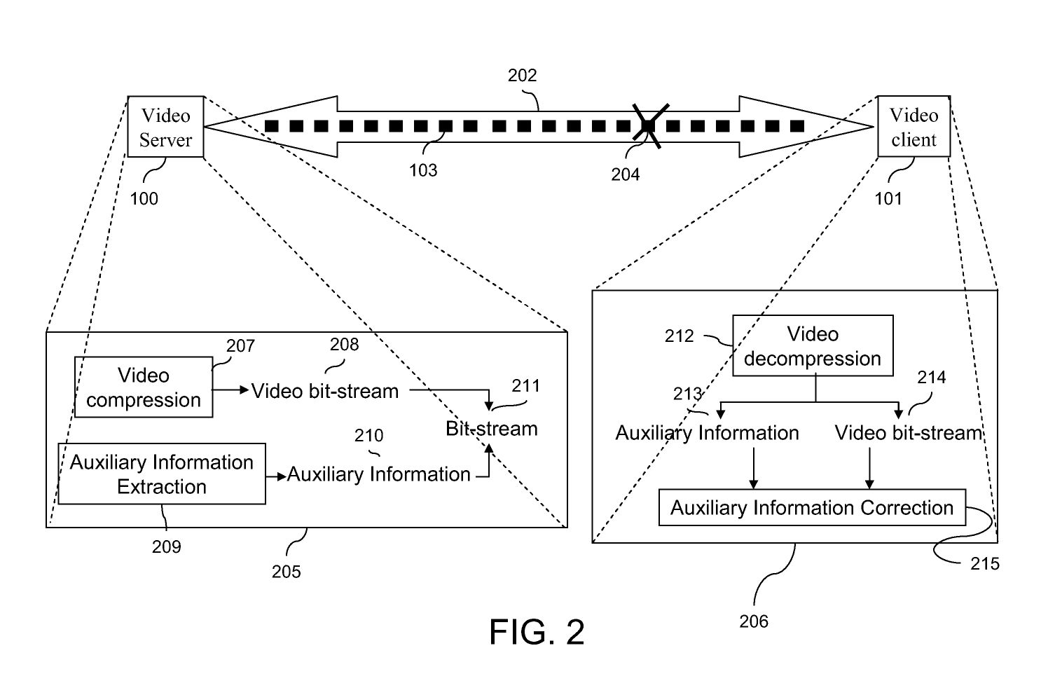

FIGS. 1 and 2 explain the context in which the present embodiments may be applied.

In FIG. 1, the role of the video server 100 is to transmit compressed video information. The compression algorithm can be MPEG-1, MPEG-2, H.264/AVC, etc. By way of example, the present specific description will refer to the properties of the H.264/AVC video standard.

The server 100 sends a video data bitstream in the form of IP/RTP packets 103 over a first network link 102. The compressed bitstream (elementary stream generated by the server) is split into sub-parts (slices). These slices are embedded as VCL NALU (Video Coding Layer Network Abstraction Layer Units) into the IP/RTP packets 103.

When a video bitstream is being manipulated (e.g. transmitted or encoded, etc.), it is useful to have a means of containing and identifying the data. To this end, a type of data container used for the manipulation of the video data is a unit called a Network Abstraction Layer Unit (NAL unit or NALU). A NALU—rather than being a physical division of the frame as the macroblocks described above are—is a syntax structure that contains bytes representing data. Different types of NALU may contain coded video data or information related to the video data. A set of successive NALUs that contributes to the decoding of one frame forms an Access Unit (AU).

Returning to FIG. 1, each NALU of the video bitstream is inserted as a payload into a real-time transport protocol (RTP) packet 103. The first network link 102 may be a wired or wireless network. In the case of a wired network, for example, the network links are usually connected with routers 106. A router is composed of a queue that stores the packets before resending them on another link in the network. In FIG. 1, the second link 105 may be a separate, wireless network. If the capacity of the second link 105 is lower than the capacity of the previous link 102 or if several links are connected to the router 106, some IP packets can be lost due to the lack of capacity (or congestion) in the queue of the router 106. For example, a packet 108 may be lost because the queue in the router 106 is full. Such losses are called congestion errors. Due to the high occupancy level of the queue in the router, the transfer duration of the packet (i.e. the time it takes to transfer the packet) is increased. When there is congestion, the global transmission (called ROTT for Relative One way Trip Time) duration of a packet between the server and the client is usually increased.

The wireless network is subject to interferences 109. For example, microwaves can pollute the wireless network. In such a case, some packets 110 may be lost. The distance between two losses caused by interference is usually higher than the distance between two losses caused by congestion. However, it is possible that losses caused by interference are also close or even consecutive.

Finally, in FIG. 1, the wireless network is connected via a router 107 to a wired network link 104 and the packets are received by the video client 101. If no protection is used, or if the protection is not sufficient, several video packets in this embodiment will be missing at the video client 101. In other words, a part of the video bitstream is lost, which means that slices or NALUs are lost because of the loss of the RTP packets.

To compensate for these losses, it is possible to use error concealment algorithms for reconstructing the missing part of the video as discussed above. However, the reconstruction quality is often poor and auxiliary information is usually necessary for helping the error concealment. It is proposed herein to use a new algorithm that has as an aim to generate a very low quantity of auxiliary information. This low quantity of auxiliary information enables the improvement of the reconstruction quality in comparison to classic error concealment. As this quantity of auxiliary information is very low, its transmission is easy.

FIG. 2 shows the detail of a context of an embodiment of the present invention. As explained with respect to FIG. 1, the video server 100 transmits video data through a network 202 to a video client 101. The network can be wired or wireless or a combination of wired and wireless. The server 100 sends video data in the form of IP/RTP packets 103 and some packets 204 may be lost.

The main modules of the server 100 are shown schematically in box 205. In a video encoder 207, the video compression (e.g. H.264) algorithm compresses the input video data and generates a video bitstream 208. In parallel, auxiliary information 210 is calculated in an auxiliary information extraction module 209. The auxiliary information 210 may be created by the encoder itself or by an external transcoder, which takes as an input the encoded video data and creates the auxiliary information from that.

This auxiliary information 210 is related to the motion information between consecutives frames of the video bitstream. The extracted auxiliary information 210 is merged with the video bitstream 208 to give rise to a final bit-stream 211 that will be transmitted to the client. For example, the auxiliary information is put in an SEI (Supplemental Enhancement Information) of the H.264 or H.264/AVC or other type of bitstream. The SEI is optional information that can be embedded in the bitstream (in the form of a NALU). This information can be ignored by the decoder not aware of the syntax of the SEI. On the other hand, a dedicated video decoder can read this SEI and can extract the auxiliary information as appropriate.

The main modules of the video client 101 are shown in box 206. The video decompression is first triggered in a decoder 212. Assuming, for this module, that the received RTP packets have been successfully received, the video decompression corresponds to the extraction of the different NALUs of the bitstream and the decompression of each NALU. Two kinds of information are extracted:

The auxiliary information 213; and

The video 214 which is not related to the auxiliary information.

If RTP packets have been lost during the video transmission (e.g. packets 204), an error correction algorithm based on the motion auxiliary information is run in an auxiliary information correction module 215.

The embodiments of the present invention are particularly concerned with creating the auxiliary information 210 and 213 in both the video server 100 and in the video client 101. Optimally, the auxiliary information that is transmitted is minimal, but with sufficient information to reconstruct blocks even when information for reconstructing those blocks has been lost in a lost packet. The embodiments of the present invention are also concerned with how the video server and the video client can use an optimal amount of auxiliary information most efficiently to obtain correctly-reconstructed blocks from the successfully-received information.

According to an embodiment of the invention, the encoder 207 in the video server 100 and the decoder 212 in the video client 101 perform the creation and use of the auxiliary information in the following way.

At the encoder (or transcoder), for a frame I(t):
generating an irregular grid based on the motion vectors of the previous frame I(t−1);
down-sampling the motion vector field of the frame I(t) based on the irregular grid; and
transmitting the down-sampled motion vector field as auxiliary information.
   At the decoder, for a frame I(t) subject to lost slices, the lost slices are concealed by:
generating an irregular grid based on the motion vector field of the previous frame I(t−1);
reading the auxiliary information of the motion vectors for the present frame I(t);
associating the read motion vectors with the irregular grid for the lost slices of the frame I(t); and
conducting motion compensation for the lost slices.

By “irregular grid”, what is meant is that a motion vector field is divided in such a way that areas each defined by a motion vector vary in size over the motion vector field. The appearance of the irregular grid and the way in which it is generated, as well as how it is down-sampled, will be described in more detail below.

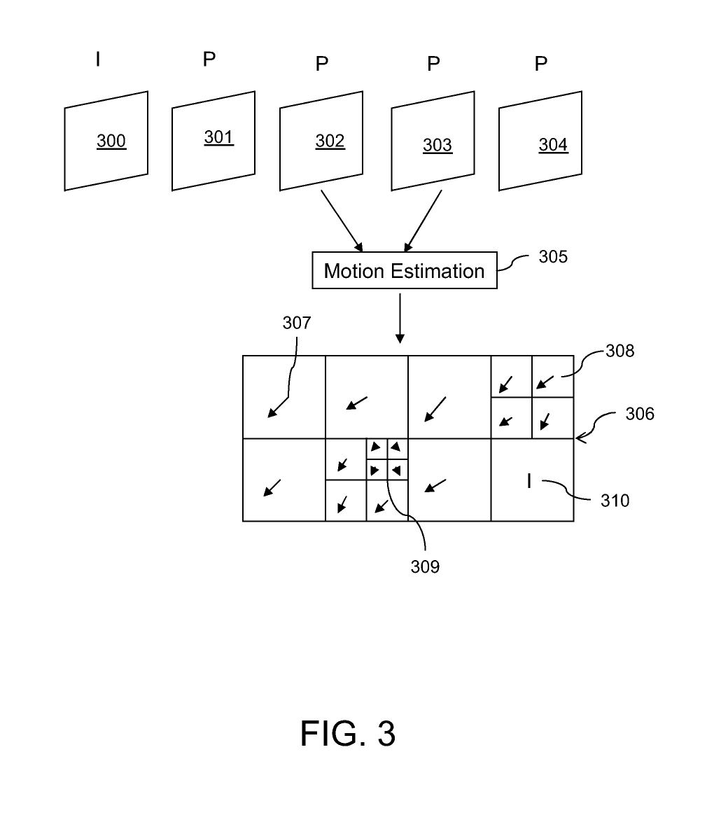

FIG. 3 illustrates the motion vector estimation step of the compression algorithm. Five consecutive frames are shown and labelled 300, 301, 302, 303 and 304. These frames are encoded either as Intra frames (labelled I) in 300 or as Inter frames (labelled P) in 301, 302, 303 and 304. The Intra frame is encoded independently of the other frames whereas the Inter frames are encoded with reference to other frames. It is assumed in this case that the Inter frames are encoded with reference to their respective previous frame. For example, the frame 303 is encoded in reference to the frame 302.

In motion estimation module 305, the encoder estimates the motion between the frame 303 and the frame 302. The motion estimation algorithm may be a block-matching algorithm. The result of this motion estimation is the motion vector field 306. Specifically, this motion vector field 306 is a symbolic representation of the motion vector field calculated by the motion estimation module 305.

The motion vector field 306 may represent a frame having a size of 64×32 pixels. In the embodiment shown, the frame is composed of 8 macroblocks of 16×16 pixels each. Each of the macroblocks is potentially divisible to create the irregular grid as explained below.

According to the complexity of the motion between the frames 303 and 302, the macroblocks can be decomposed into either 8×8 pixel blocks or 4×4 pixel blocks. For example, in a first macroblock 307, one motion vector is associated with the 16×16 macroblock. In macroblock 308, one motion vector is associated to each 8×8 block (so there are four motion vectors allocated to the macroblock 308). In macroblock 309, one motion vector is associated to each 4×4 block within one of the 8×8 blocks. A larger number of motion vectors may be allocated to a block or macroblock with more complex motion. If the motion is too complex or the trade-off in terms of rate/distortion optimization is bad, no motion vector is calculated and the macroblock is encoded as an Intra macroblock. Such a case is depicted in macroblock 310.

The motion vector field 306 calculated by the video encoder is a starting point for calculating the auxiliary information related to the frame 303. This motion information can be directly obtained during the video compression operation or obtained from a partial decoding of an already-encoded video bitstream.

Auxiliary information is preferably associated to each Inter frame of the video (unless there has been no relative movement between frames and the residual has a zero value). The auxiliary information related to the frame I(t) will thus be called AI(t). As mentioned above, there is no auxiliary information accompanying Intra frames, as these are encoded without motion vectors or residuals.

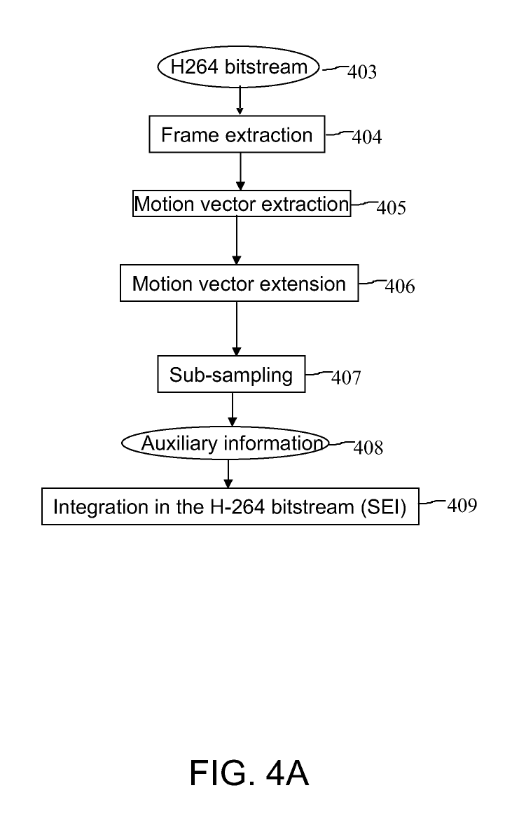

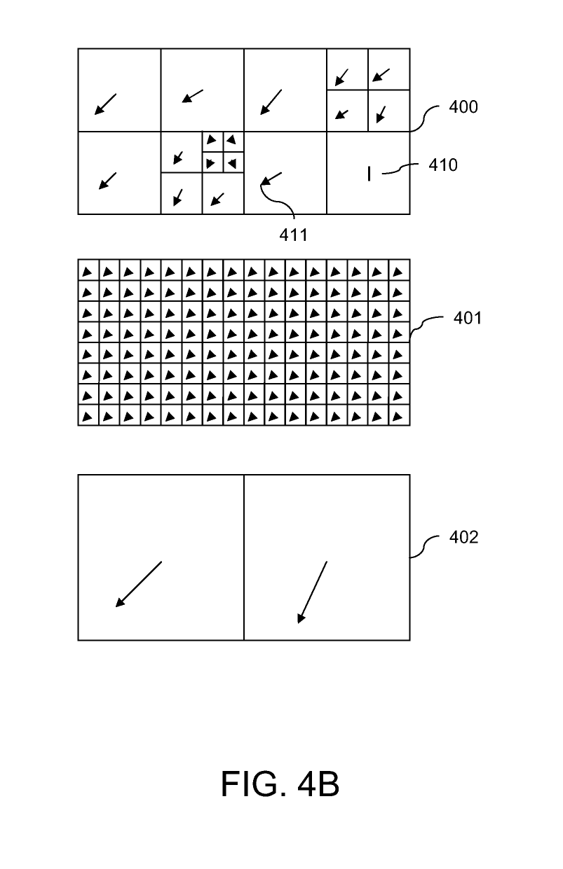

FIGS. 4A and 4B illustrate the generation of the auxiliary information AI(t) for a given Inter frame I(t). The generation process takes some elements already developed in FIG. 3 and adds further elements. FIG. 4A is a first partial explanation of an embodiment of the invention and does not take into account the irregular sub-sampling related to the generation of irregular auxiliary information. Only the regular auxiliary information is explained. The irregular case will be explained with respect to the following figures. FIGS. 4A and 4B are for illustrating the motion vector field down-sampling in particular.

Supposing that the motion vector field 306 generated for the frame 303 in FIG. 3 is the basis for calculating the auxiliary information, this motion vector field 306 is also displayed in FIG. 4B as motion vector field 400.

The beginning of the process for generating the auxiliary information for the frame I(t) is now described with reference to FIG. 4A. The bitstream is obtained in step 403 and the bitstream corresponding to the frame I(t) is extracted from the bitstream in step 404. From this bitstream, the motion vector information is also extracted in step 405. This motion vector information extraction 405 gives rise to the motion vector field 400 of the frame I(t) shown in FIG. 4B.

In step 406, the motion vector field 400 is extended. This extension consists of attributing a motion vector to each 4×4 block of the motion vector field 306. The extension consists of replicating the motion vector of an 8×8 or 16×16 block or macroblock to the corresponding 4×4 blocks within the larger block or macroblock. For example, all 4×4 blocks within the macroblock 311 will be allocated the same motion vector as macroblock 311. The extension also consists of interpolating the motion vector values to the blocks without motion vectors (e.g. block 310). For example, the missing motion vector information in 310 could be created by replicating the neighbouring motion vector 311 during the interpolation process. The skilled person would understand various ways of interpolating motion vectors for blocks that do not have their own, such as averaging the motion vectors of surrounding blocks, etc. The extension gives rise to the extended motion vector field 401 of FIG. 4B.

Once a motion vector is associated with each 4×4 block as shown in motion vector field 401 in FIG. 4B, a sub-sampling process is run in step 407. The sub-sampling process basically allocates motion vectors to larger areas so that there is less information. The larger-scale motion vectors may be averages of the motion vectors of several neighbouring blocks. For example, this sub-sampling may consist of attributing two motion vectors to the whole frame as shown in motion vector field 402 in FIG. 4B. These two motion vectors may become the auxiliary information in step 408 and can be transmitted through the SEI in the bitstream in step 409 to the video client 101. Because there are only two motion vectors in the final motion vector field 402, the auxiliary information sent in the bitstream is very small.

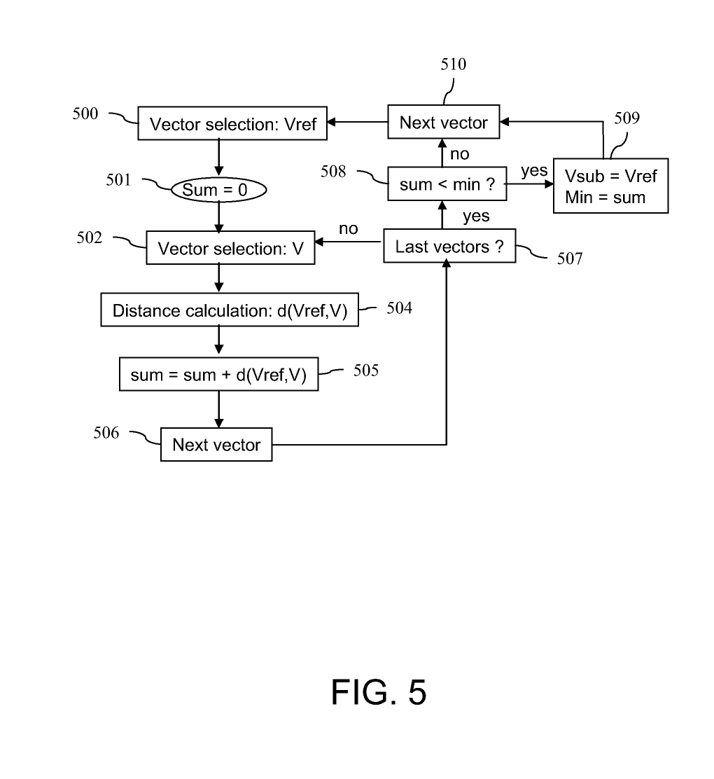

FIG. 5 gives more detail about methods of sub-sampling a motion vector field or a part of the motion vector field. It corresponds to the sub-sampling operation 407 described above with respect to FIG. 4A. The method shown in FIG. 5 consists of choosing, from among the motion vectors in the motion vector field, the vector that minimizes an error with respect to the other motion vectors. This process is based on two loops:
the first loop comprises selecting each motion vector in turn of the set of motion vectors that will be down-sampled; and
the second loop calculates, for each selected motion vector, an error with respect to all the other motion vectors.

Each vector (among the set of vectors of the motion vector field that are to be sub-sampled) is successively selected in step 500 within what is defined above as the first loop. The presently-selected vector is called Vref. As mentioned above, there are two loops that are linked in the sub-sampling process and the idea is to select one from the motion vectors that has the smallest cumulative error determined in particular in step 505 as shown in FIG. 5 with respect to the other motion vectors. For example, if there were three motion vectors V1, V2 and V3, V1 would be selected first and its error with respect to V2 and V3 would be found (this is the loop defined by steps 502, 504, 505, 506 and 507). The same thing would then be done for V2 and for V3. For each of the motion vectors V1, V2 and V3, as an error is calculated, a variable sum must be initialised. Thus, in the example shown in FIG. 5, for this vector Vref, a variable sum is set to 0 in step 501. Next, each vector V (from the set of vectors of the motion vector field that are to be sub-sampled) is selected in step 502. The distance d(Vref,V) between these two vectors is calculated in step 504 and added in step 505 to the variable ‘sum’ calculated in 501. The distance calculation of step 504 is based on the L1 norm where there are two motion vectors V₁ and V₂: d(V₁,V₂)=|V₁^{x}−V₂^{x+|+V}₁^{y}−V₂^{y}|; where x and y represent the position of the motion vectors in the x-y plane (i.e. in the dimensions of the frame). If not all the vectors have been tested in steps 506 and 507, the rest of the vectors of the set of vectors of the motion vector field to be sub-sampled are selected and processed as above (the steps 502, 504, 505, 506 continue).

When it is established in steps 506 and 507 that all the vectors have been tested, the sum of step 505 is compared in step 508 to a minimum value. If this sum is lower than the minimum (yes in step 508), the reference vector (Vref) is selected as the sub-sampled vector in step 509. A new value for Vref is set in step 510 (from among the set of vectors of the motion vector field that are to be sub-sampled). If, in step 508, the sum of step 505 is not less than a minimum, the process starts again with the next vector selected as Vref in step 500.

Experimental results have shown that this method for calculating a sub-sampled motion vector produces better results than the average motion vector:

$$\vec{V} = \frac{1}{N} {\sum }_{i = 1}^{N} \vec{{V}_{i}}$$

(the average motion vector is the vector that minimises the least square distance d(V₁,V₂)=(V₁^{x}−V₂^{x})²+(V₁^{y}−V₂^{y})²), though the latter is also a legitimate way of obtaining the sub-sampled motion vector according to an embodiment of the present invention.

Thus, FIG. 5 explains how to subsample one set of motion vectors of a motion vector field. Other algorithms could be used but this algorithm provides a good quality.

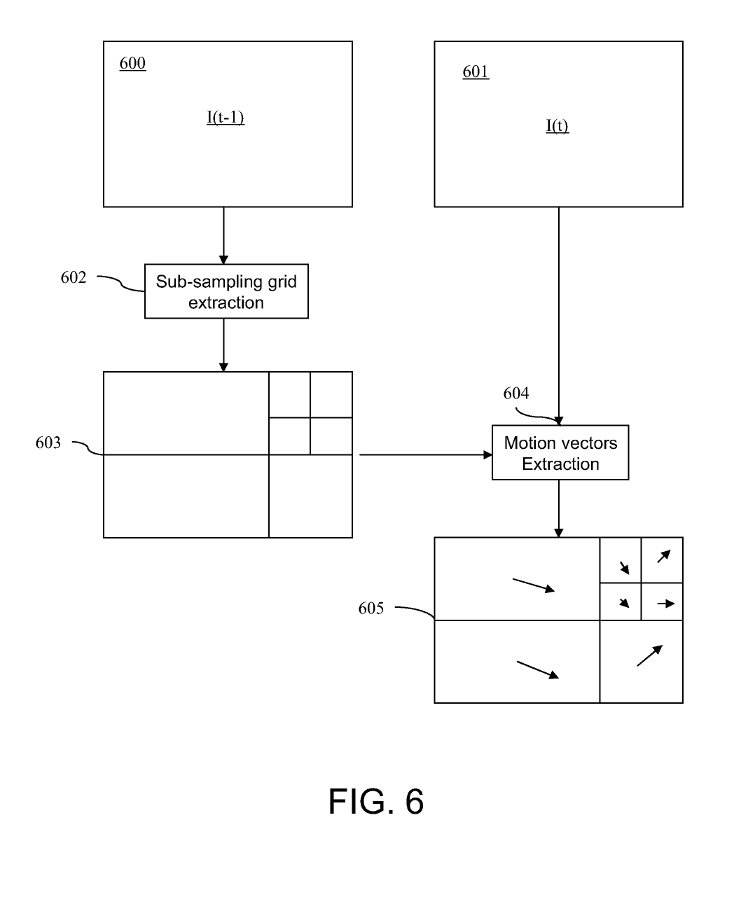

FIG. 6 illustrates the creation of an irregular grid used for calculating the motion information (auxiliary information) according to a preferred embodiment of the present invention. As the irregularity is preferably calculated symmetrically both in the encoder and in the decoder, no auxiliary information is necessary for transmitting this irregular grid.

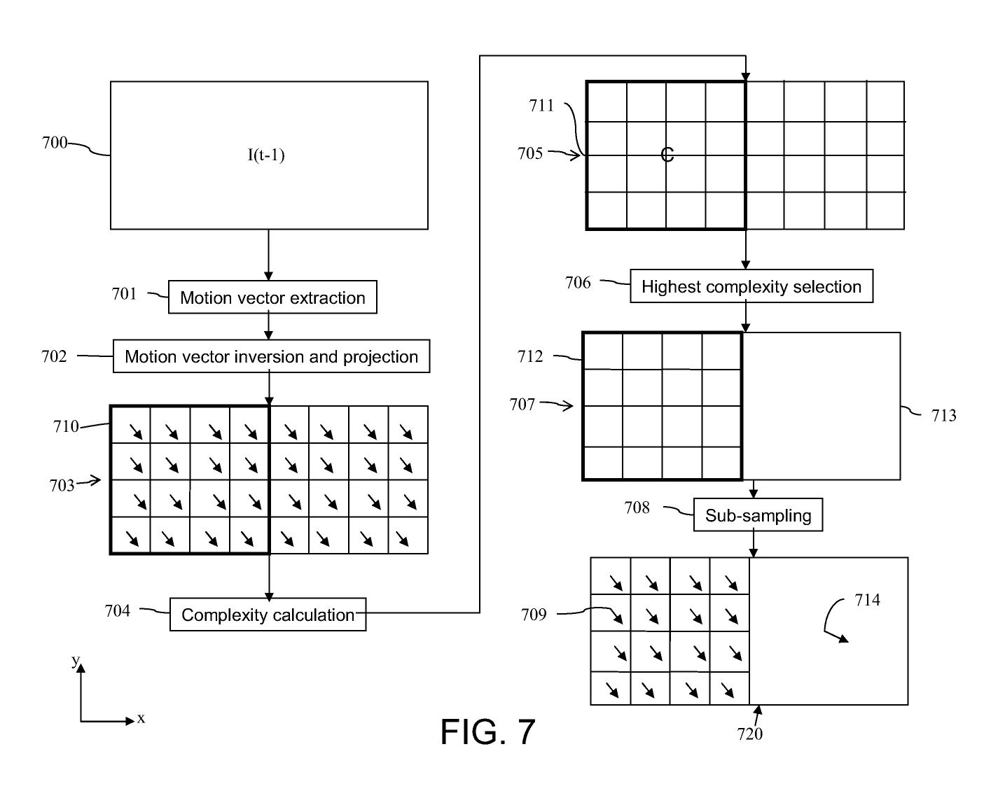

FIG. 6 shows the preferred embodiment. The method includes calculating an irregular grid (which can be calculated in the same way in both the video encoder and the video decoder) that is used for sub-sampling the motion vector field of the frame I(t). The basic idea is to use a denser sub-sampling pattern on areas with high motion complexity and a sparser pattern on areas with low motion complexity. FIG. 6 explains the main principles. More details about the algorithm are given below with reference to FIG. 7.

The principle of the creation of the irregular grid is to obtain an irregular grid that can be constructed symmetrically both in the encoder and in the decoder without transmitting auxiliary information. In other words, it is desirable for both the encoder and the decoder to be able to recreate the same irregular grid. Once the grid is constructed, it can be used at the encoder for extracting the motion auxiliary information as explained with respect to step 408 in FIG. 4A. As the grid is symmetrically reconstructed in the decoder, the received motion auxiliary information can be allocated to the right place in the frame by the decoder based on this irregular grid. Thus, only the motion vectors resulting from the sub-sampling of the motion vector field need to be transmitted as auxiliary information; the irregular grid to which the motion vectors are attributed does not need to be transmitted. This has the effect of keeping the transmitted auxiliary information to a minimum.

According to a preferred embodiment of the invention, the auxiliary information may have a fixed budget or threshold of bandwidth to be allocated to motion vectors. Thus, the number of motion vectors, and therefore the format of the irregular grid, may be tailored (i.e. limited) to this budget. The threshold of complexity in the complexity map for a specific size of cell of the irregular grid may thus be dictated by the total number of grid cells permitted. For instance, in a case where there is little bandwidth and therefore a small budget for motion vectors in the auxiliary information, the complexity threshold over which small cells will be formed will be higher than if a large budget is available. In the example illustrated in the FIG. 7, there is budget in the bandwidth for 17 motion vectors and so small cells each with a motion vector and one large cell with its own motion vector are created in the irregular grid. The same budget is given to both the encoder and the decoder so that the same complexity thresholds are used and the same irregular grid is generated.

In 600, the image I(t−1) is displayed. The frame I(t) in this case is subject to slice losses. If no loss occurs on this frame I(t−1) during the transmission, the same frame is available both in the encoder and in the decoder. In 601, the encoded frame I(t) is displayed.

The irregular grid 603 is constructed in step/module 602 based on the frame I(t−1) (i.e. the frame preceding the current frame containing the losses). As the frame I(t−1) is not subject to slice loss, this grid can also be constructed by the decoder (in the same way as it had been constructed by the encoder and as explained below with reference to FIG. 7). Once the irregular grid is constructed, the motion vectors corresponding to each block of the irregular grid can be extracted in step/module 604 at the encoder to give rise to the filled-in irregular grid 605. The motion vectors are transmitted to the decoder.

Once the irregular grid is constructed at the decoder side, the received motion vectors (from the auxiliary information) corresponding to each block of the irregular grid can be allocated to the right place in the grid at the decoder. With respect to the process shown in FIG. 6, when applied to the decoder, the motion extraction stage 604 is replaced by a stage of reading the motion auxiliary information.

FIG. 6 shows the main principle of the irregular grid creation: using the previous frame I(t−1) for constructing the irregular grid on the frame I(t). FIG. 7 gives more details of this process. The process shown in FIG. 7 can be performed both at the server and at the client. In this figure, the server is taken as the example. Therefore, once the irregular grid is calculated, the goal of the process at the server is to calculate the motion vector auxiliary information based on this irregular grid (including motion down-sampling as explained with reference to FIG. 5).

On the other hand, when the process of the FIG. 7 is calculated at the client, the process which is described below has as its goal to read the motion vectors from the auxiliary information and to allocate the read motion vectors to their correct locations (the locations being given by the irregular grid).

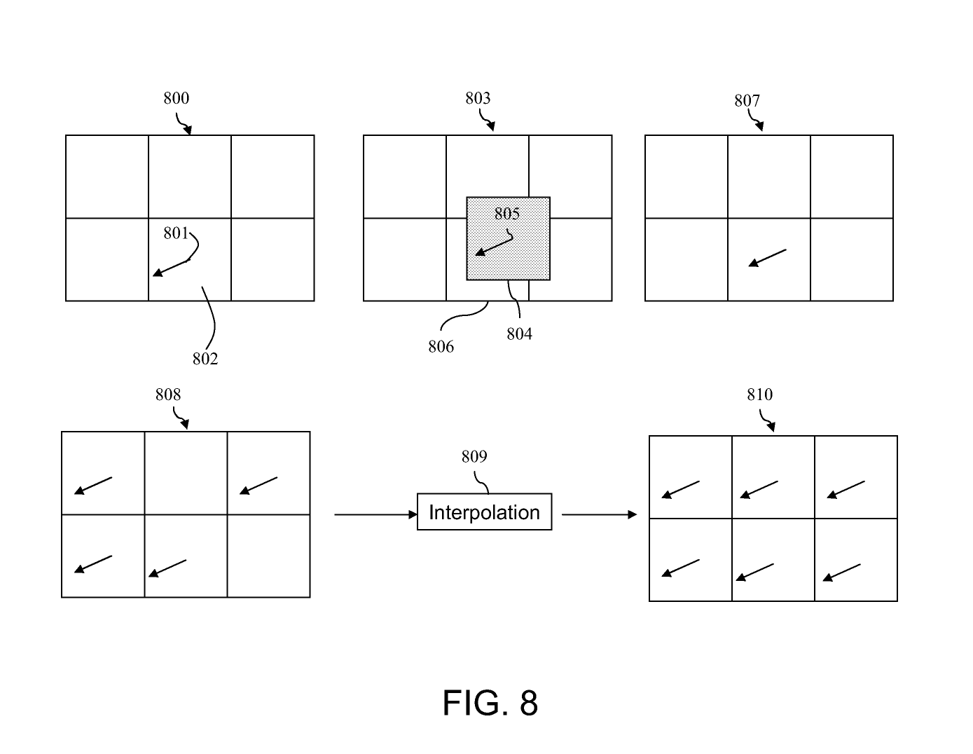

In stage 700, the encoded frame I(t−1) is displayed. The motion vector field associated with this frame is extracted in 701. This motion vector field may be characteristic of the motion between the frame I(t−1) and the frame I(t−2), for example. The way this motion vector field is calculated is similar to the process described in the steps 404, 405 and 406 of FIG. 4A (i.e. the motion vectors are extracted and extrapolated for associating one motion vector to each block of 4×4 pixels). This motion vector field is then inverted and projected in step/module 702 onto the frame I(t). The inversion and the projection of the motion vector field are described with reference to FIG. 8.

FIG. 8 explains the step/module 702 of FIG. 7 which is the inversion and the projection of the motion vector field. The goal of the inversion and projection process is to construct a motion vector field for the frame I(t) based on the motion vector field of the frame I(t−1).

The frame I(t−1) is labelled 800 and is the starting point for the process. Each cell of the frame contains an associated motion vector: for example, the motion vector 801, which can be represented as V(x,y)=(Vx,Vy), is associated with the block 802. The coordinates (x,y) are taken as being the centre of the block 802.

This motion vector 801 is inverted, giving: −V(x,y)=(−Vx, −Vy). Following the direction of the inverted vector thus gives the equivalent position of the block in the subsequent frame I(t) that is equivalent to the block 802 in frame I(t−1). The block 802 is thus projected onto the frame I(t) 803 according to this inverted motion vector 805 and results in block 804. The centre of block 804 in frame I(t) is at the position represented by (x−Vx, y−Vy).

The value of the motion vector 805 associated with this block 804 is the same value as the original uninverted motion vector, namely V(x,y)=(Vx,Vy).

As can be seen from frame I(t) labelled 803, the inversion-produced block 804 shares the largest common area with the cell 806 from among all the cells of the frame I(t). Thus, the value of the motion vector V(x,y) 805 is attributed to the cell 806 as depicted in the resultant frame 807. The same inversion and projection process is repeated for all the cells of the frame I(t−1). An example of the result of this process is shown in frame 808. After this first process, some cells have no corresponding motion vectors because the motion vector inversion process has not led to a majority overlap of the inversion-produced block with those cells. An interpolation stage 809 may thus be conducted to enable the obtaining of a full motion vector field 810 for the frame I(t). The interpolation may be performed in a similar way to the interpolation described above with respect to the motion vector extension 406 shown in FIGS. 4A and 4B. This results in a motion vector field that is precise enough to calculate the complexity map 704 of FIG. 7, as will be described below.

Returning to FIG. 7, the resulting inverted and projected motion vector field (now associated with frame I(t)) is now labelled 703 (and is equivalent to frame 810 of FIG. 8). From this motion vector field, which is an approximation of the true motion vector field of the encoded frame I(t), a complexity map can be calculated in step/module 704.

In the example illustrated in this figure, the complexity map calculation consists of calculating the maximum variation of motion vector size (i.e. by measuring the variance of a plurality of 4×4 blocks) with respect to ‘adjacent’ motion vectors. By adjacent, what is meant is either the nearest neighbours (top, bottom, left, right) or the nearest and next nearest neighbours (including diagonal nearest motion vectors), or even all of the motion vectors in a single block.

The maximum variation of vector size represents the maximum motion with respect to the previous frame. A higher complexity value therefore represents a greater motion in the relevant blocks, which will, in further steps described below, give rise to a higher density of motion vectors in the motion vector field for those blocks with higher complexity values. The complexity map therefore is created in order to determine the density of motion vectors to be output from the sub-sampling step/module.

Blocks of 4×4 motion vectors are extracted from the motion vector field (such as block 710 of the motion vector field 703) in stage 701. The variances of the horizontal and vertical components of these 16 motion vectors are calculated (i.e. the variance of each motion vector angle with respect to the x-axis as viewed in FIG. 7 and the variance of each motion vector angle with respect to the y-axis are calculated). The maximum value of these two variances (the vertical and horizontal variances) is set as the complexity value for that block.

For example, the block of 4×4 motion vectors 710 is selected and the variances of the motion vectors are calculated in stage 704. The maximum of the horizontal and vertical variances is determined and associated to the corresponding block 711 in the complexity map 705. For example, the complexity of the block 711 is called C in FIG. 7. The same process is repeated for all the blocks of 4×4 motion vectors of the frame during the complexity calculation 704. The complexity calculation process results in the complexity map 705 in which a complexity value is associated with each block of 4×4 motion vectors.

This complexity map 705 is split into two kinds of cells 707 using the highest complexity selection step/module 706. Of course, more kinds of cells than two may be distinguished in a separate embodiment. A group of small cells (e.g. 712) corresponds to a block of 4×4 motion vectors with a high complexity value. The large cell (e.g. 713) corresponds to a block of 4×4 motion vectors with a low complexity value. The number of ‘small’ cells and ‘large’ cells depends on the number of motion vectors (to be) sent in the auxiliary information. In the illustrative example of FIG. 7, the number of motion vectors (to be) transmitted as auxiliary information is 17, of which 16 ‘small’ cells are created and 1 ‘large’ cell is created.

From the frame 705, the two 4×4 blocks are checked and the one 711 with the largest complexity will be kept as (or divided into) small cells 712 (16 cells, in the illustrated case). The second 4×4 block will be effectively combined and considered as a single large cell 713 if the complexity is low. Of course, the size of the cells can vary according the preferences of the user.

The complexity map 707 shows the two kinds of cells that are created (small and large). In the final sub-sampling stage 708, a motion vector is associated with each cell (whatever the size of the cell).

In this example, the motion vectors 709 corresponding to the small cells correspond to the motion vectors of the frame I(t) at the same location. It is noted that the frame I(t−1) was used to calculate the irregular grid format, but once this grid is calculated, with smaller and larger cells, the motion vectors for each block are calculated using the motion in the frame I(t). These motion vectors are calculated using either the motion vectors associated with a 4×4 block or by sub-sampling large blocks that have plural motion vectors.

For the large cell 713, the generation of the single motion vector 714 using the sub-sampling step/module 708 consists of applying the algorithm described with respect to FIG. 5 to the motion vectors of the frame I(t) corresponding to the position of the cell 713.

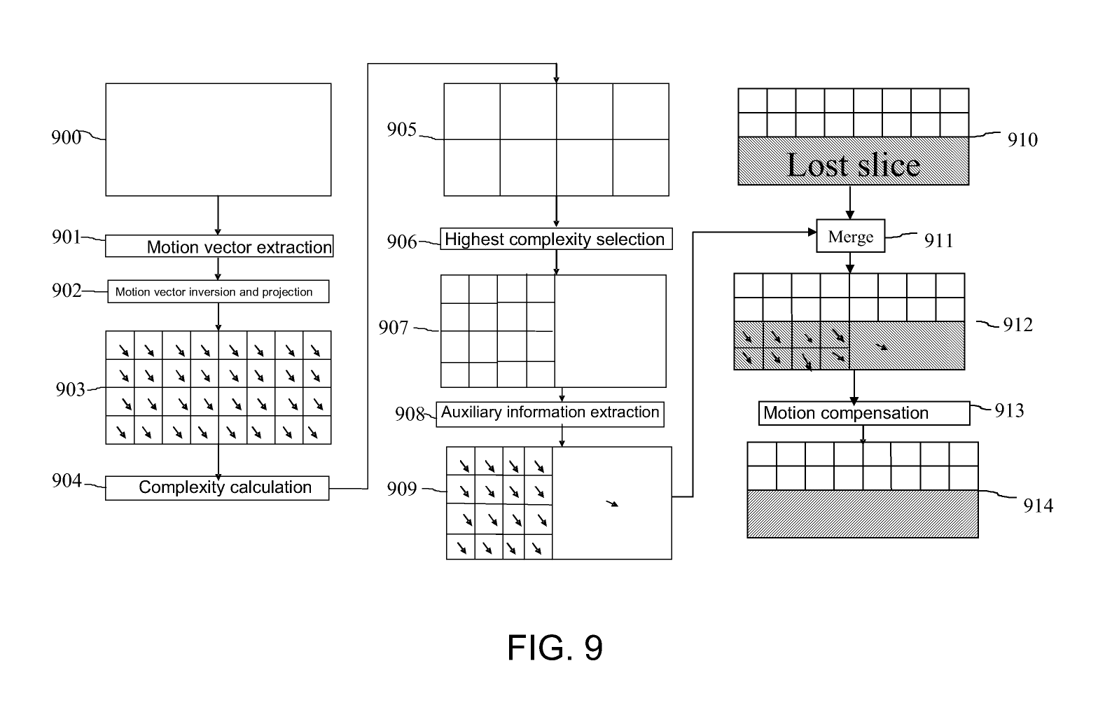

At the decoder side, the motion vector field in the irregular grid 720 is received as the auxiliary information and this is applied to the irregular grid that is independently but symmetrically calculated at the decoder from frame I(t−1) using the same method (i.e. motion comparison with I(t−2)) as the encoder. The retrieval of the motion vectors from the auxiliary information is explained above with reference to FIG. 6 and below with reference to FIG. 9.

The final result is a motion vector field containing cells of different size. This motion vector field is the auxiliary information. In other words, the number of large and small cells is shared between the server and the client so that the same irregular grid is created. The motion vector field can be compressed by an entropic encoder (e.g. arithmetic encoding). Of course, The different cells of the irregular grid need to be read on the same way both at the server and at the client. For example, a lexicographic reading adapted to the irregularity of the grid can be used. This and other methods for recognising vectors in transmitted information in a specific order so that they can be correctly applied to the cells of the irregular grid will be understood and applicable by the skilled person.

The advantage of this process of creating the complexity map is to have a larger density of motion vectors on areas with high motion complexity and a lower density of motion vectors on areas with low motion complexity. This gives rise to the irregular grid of the preferred embodiments. Thus, a minimum number of motion vectors is possible to achieve (while having those minimum of motion vectors allocated to the most appropriate blocks), which in turn reduces the amount of bandwidth required by the auxiliary information.

FIG. 9 explains how the auxiliary information is used by the video client when lost packets (and lost slices) occur. As mentioned above, the motion auxiliary information received by the video client contains only motion vectors. The irregular grid calculated by the server is not transmitted. The client will therefore recalculate the irregular grid. Once this irregular grid is calculated by the client, the auxiliary motion vectors can be inserted at the right locations.

In FIG. 9, RTP packets relating to the frame I(t) are assumed to have been lost. The result is a lost slice. For example, in frame 910, the frame I(t) is displayed and the lost slice is drawn and shaded. The goal is therefore to read the auxiliary information and to use the motion vectors therein for correcting or at least compensating for this lost slice.

First, the process for calculating the irregular grid is described.

In frame 900, the frame I(t−1) is displayed. As this frame is theoretically lossless (no slice lost on this frame), this frame is similar to the frame 700 used by the video server during the encoding process. In the motion vector extraction step/module 901, the motion vectors associated with the frame I(t−1) are extracted. These motion vectors are then inverted and projected 902 onto the frame I(t) as described with reference to FIG. 8 above to give rise to the motion vector field 903.

The complexity calculation step 904 is run by a complexity calculation module 904. Once again, this process is the same as the process conducted by the video server 704 shown with reference to FIG. 7. The complexity calculation step gives rise to the complexity map 905. This complexity map is the same as the complexity map 705 shown in FIG. 7. The cells with the highest complexity value are selected by selection module 906. The cells are split into large (low complexity value) and small (high complexity value) cells as performed by the video server. Information indicating the number of large and small cells is shared between the server and the client so that the same irregular grid is created. This number of large and small cells may form part of the auxiliary information sent from the server to the client.

Once the same irregular grid 907 is created in the client as was created in the server, the auxiliary information (i.e. the motion vectors) associated with the frame I(t) is read. Specifically, the SEI carrying the auxiliary information is read and the motion vectors are extracted in the auxiliary information extraction step/module 908. These motion vectors are inserted into the correct locations in the irregular grid 909. As mentioned above, the association of the motion vectors with the correct locations in the irregular grid is achieved by coding the motion vectors in a certain order or with specific flags or using a lexicographic reading that associate the motion vectors with the correct positions in the irregular grid.

In frame 910, one slice of the frame I(t) is lost. Though the reconstruction of the frame is correct for the received slice, no information (i.e. prediction information and residual or 1-frame information) is available for the lost slice.

In step/module 911, the motion vector information corresponding to the lost slice is inserted into frame I(t). The resulting frame is shown as 912. Thus, a full frame with motion vectors associated with each block is recreated.

In the motion compensation module 913, standard motion compensation is performed on the lost part of the frame I(t) using the resulting frame 912 (i.e. using the auxiliary motion information and the previous decoded frame I(t−1) 900). The result is the frame 914 where the lost slice has been replaced by the motion compensated information. This frame can be displayed.

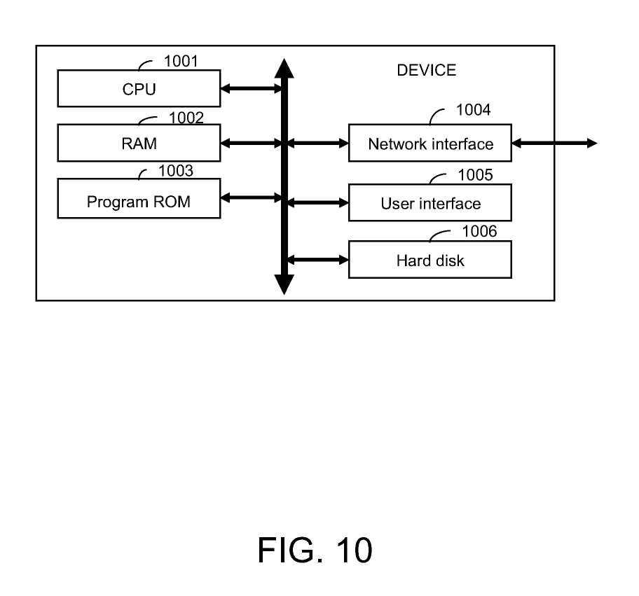

FIG. 10 illustrates a block diagram of a device server or client adapted to incorporate the invention. Preferably, the device comprises a central processing unit (CPU) 1001 capable of executing instructions from a program ROM (read-only memory) 1003 on powering up of the device, and instructions relating to a software application from main memory 1002 after the powering up. The main memory 1002 is for example a Random Access Memory (RAM) which functions as a working area of the CPU 1001, and the memory capacity thereof can be expanded by an optional RAM connected to an expansion port (not illustrated). Instructions relating to the software application may be loaded to the main memory 1002 from the hard disk (HD) 1006 or the program ROM 1003 for example. Such a software application, when executed by the CPU 1001, causes the steps described above (on either the server or client sides) to be performed. Reference numeral 1004 is a network interface that allows the connection of the device to the communication network. The software application when executed by the CPU is adapted to receive data streams through the network interface from other devices. Reference numeral 1005 represents a user interface to display information to, and/or receive inputs from, a user. Thus, the methods and processes above may be performed by a device such as that shown in FIG. 10.

The skilled person may be able to think of other applications, modifications and improvements that may be applicable to the above-described embodiment. The present invention is not limited to the embodiments described above, but extends to all modifications falling within the scope of the appended claims.

1. An encoder for encoding a first frame I(t) of a video bitstream, the first frame being defined by a plurality of blocks of pixels, the encoder comprising:
means for generating an irregular grid of cells, each cell having a size generated according to motion information of a second frame I(t−1) of the video bitstream;
means for generating motion vectors to be applied to each cell of the irregular grid, the generated motion vectors being representative of the motion in the first frame I(t) of the video bitstream; and
means for transmitting the generated motion vectors to a decoder.

2. An encoder according to claim 1, wherein the means for generating the irregular grid of cells is configured to generate each cell of the irregular grid of cells according to a complexity of a motion vector field derived from the motion information of the second frame I(t−1) of the video bitstream.

3. An encoder according to claim 1, further comprising:
means for deriving an estimated motion vector field for the first frame I(t) from the motion information of the second frame I(t−1), the deriving means comprising:
means for obtaining motion vectors for a plurality of blocks of the second frame I(t−1);
means for inverting the motion vectors for the plurality of blocks of the second frame I(t−1);
associating means for associating blocks of the second frame I(t−1) with blocks of the first frame I(t) using the inverted motion vectors; and
assigning means for assigning each respective motion vector for each block of the plurality of blocks of the second frame I(t−1) to each respective block of the first frame I(t) with which the former is associated by the associating means.

4. An encoder according to claim 3, wherein:
the associating means comprises:
means for projecting each block of the plurality of blocks from the second frame I(t−1) onto the first frame I(t) using the inverted motion vectors; and
means for determining with which block of the first frame I(t) each projected block overlaps the most, and wherein
the assigning means is configured to assign each respective motion vector for each block of the plurality of blocks of the second frame I(t−1) to each respective associated block in the first frame I(t) with which each respective projected block overlaps the most such that each block with which a projected block overlaps the most is assigned a motion vector.

5. An encoder according to claim 4, wherein the assigning means further comprises:
means for extrapolating a motion vector to any block in the first frame I(t) that does not have a motion vector assigned to it in order to generate an estimated motion vector field for all blocks of the first frame I(t).

6. An encoder according to claim 4, wherein the means for generating the irregular grid of cells is configured to calculate a complexity value for motion vectors of the motion vector field based on a variance of the motion vectors of the projected blocks.

7. An encoder according to claim 1, further comprising:
means for determining a complexity map comprising complexity values of a motion vector field derived from the motion information of the second frame I(t−1).

8. An encoder according to claim 6, wherein the means for generating the irregular grid comprises:
means for grouping blocks together that have a low complexity value into a large cell with a single motion vector representing the motion in the large cell, and for grouping or dividing blocks that have a high complexity value into small cells, each having motion vectors representing the motion in each small cell; and
means for generating the irregular grid made up of the large and/or small cells.

9. An encoder according to claim 1, wherein the means for generating the irregular grid is configured to obtain an indication of the maximum number of motion vectors that may be allocated to the first frame I(t) and to generate the irregular grid with a number of cells corresponding to this maximum number of motion vectors.

10. An encoder according to claim 1, wherein the means for generating the irregular grid of cells comprises:
means for generating a motion vector field for the second frame with regular blocks based on encoded block motion vectors of the second frame I(t−1);
means for generating a regular grid associated with the first frame I(t) by projecting the regular-block motion vector field of the second frame I(t−1) onto the first frame I(t); and
means for splitting and/or grouping the regular grid of the frame I(t) into sets of cells, all cells in a set being the same size.

11. An encoder according to claim 10, wherein the splitting and/or grouping means is further configured to split and/or group the regular grid of the first frame I(t) into sets of regularly- or irregularly-sized cells based on a calculation of a complexity value of motion of the first frame determined using the motion information of the second frame I(t−1).

12. An encoder according to claim 1, wherein the means for generating the regular grid is configured to interpolate a motion vector to any block in the first frame that does not have a block from the second frame projected onto it.

13. An encoder according to claim 1, wherein the means for generating a motion vector to be applied to each cell of the irregular grid is configured to base its generation on the selection of a motion vector of a block in said cell from among motion vectors of blocks in said cell, the selected motion vector having a minimal error with respect to the motion vectors of other blocks within the same cell.

14. An encoder according to claim 1, wherein the second frame I(t−1) immediately precedes the first frame I(t).

15. A decoder for decoding a first frame I(t) of a video bitstream, the decoder comprising:
means for generating an irregular grid of cells, each cell having a size generated according to motion information of a second frame I(t−1) of the video bitstream at the respective position of the cell;
means for receiving motion vectors from an encoder to be applied to each cell of the irregular grid, the received motion vectors representing the motion of the first frame I(t) of the video bitstream at the position of the cell; and
means for applying the received motion vectors to the cells of the generated irregular grid to generate a motion vector field to be used for motion prediction of the first frame I(t).

16. A decoder according to claim 15, wherein the means for generating an irregular grid of cells is configured to generate each cell of the irregular grid of cells according to a complexity of a motion vector field derived from the motion information of the second frame I(t−1) of the video bitstream.

17. A decoder according to claim 15, further comprising:
means for deriving an estimated motion vector field for the first frame I(t) from the motion information of the second frame I(t−1), the deriving means comprising:
means for obtaining motion vectors for a plurality of blocks of the second frame I(t−1);
means for inverting the motion vectors for the plurality of blocks of the second frame I(t−1);
associating means for associating blocks of the second frame I(t−1) with blocks of the first frame I(t) using the inverted motion vectors; and
assigning means for assigning each respective motion vector for each block of the plurality of blocks of the second frame I(t−1) to each respective block of the first frame I(t) with which the former is associated by the associating means.

18. A decoder according to claim 17, wherein:
the associating means comprises:
means for projecting each block of the plurality of blocks from the second frame I(t−1) onto the first frame I(t) using the inverted motion vectors; and
means for determining with which block of the first frame I(t) each projected block overlaps the most; and wherein
the assigning means is configured to assign each respective motion vector for each block of the plurality of blocks of the second frame I(t−1) to each respective block in the first frame with which each respective projected block overlaps the most such that each block with which a projected block overlaps the most is assigned a motion vector.

19. A decoder according to claim 17, wherein the assigning means comprises:
means for extrapolating a motion vector to any block in the first frame I(t) that does not have a motion vector assigned to it in order to generate an estimated motion vector field for all blocks of the first frame I(t).

20. A decoder according to claim 18, wherein the means for generating the irregular grid of cells is configured to calculate a complexity value for motion vectors of the motion vector field based on a variance of the motion vectors of the projected blocks.

21. A decoder according to claim 15, wherein the means for generating the irregular grid of cells comprises:
means for reading a plurality of blocks of the second frame I(t−1);
means for generating a complexity map by determining a complexity value representing the extent of motion in each block of the second frame I(t−1);
means for grouping blocks together that have a low complexity value into a large cell with a single motion vector representing motion in the large cell, and for grouping or dividing blocks that have a high complexity value into small cells, each having motion vectors representing the motion in each small cell; and
means for generating the irregular grid made up of the large and/or small cells.

22. A decoder according to claim 21, wherein the means for calculating the complexity map is configured to calculate a complexity value for motion vectors of the motion vector field from a variance of the motion vectors of the blocks in the second frame I(t−1).

23. A decoder according to claim 15, wherein the means for generating the irregular grid of cells comprises:
means for generating a motion vector field for the second frame with regular blocks based on encoded block motion vectors of the second frame I(t−1);
means for generating a regular grid associated with the first frame I(t) by projecting the regular-block motion vector field of the second frame I(t−1) onto the first frame I(t); and
means for splitting and/or grouping the regular grid of the frame I(t) into sets of cells, all cells in a set being the same size.

24. A decoder according to claim 23, wherein the splitting and/or grouping means is further configured to split and/or group the regular grid of the first frame I(t) into sets of regularly- or irregularly-sized cells based on a calculation of a complexity value of motion of the first frame determined using the motion information of the second frame I(t−1).

25. A decoder according to claim 15, wherein the means for generating the regular grid is configured to interpolate a motion vector to any block in the first frame that does not have a block from the second frame projected onto it.

26. A decoder according to claim 15, wherein the means for generating a motion vector to be applied to each cell of the irregular grid is configured to base its generation on the selection of a motion vector of a block in said cell from among motion vectors of blocks in said cell, the selected motion vector having a minimal error with respect to the motion vectors of other blocks within the same cell.

27. A decoder according to claim 15, wherein the second frame I(t−1) immediately precedes the first frame I(t).

28. A decoder according to claim 15, wherein, when blocks in the first frame I(t) are lost before reaching the decoder, the means for applying the received motion vectors to the cells of the generated irregular grid is configured to apply the received motion vectors only to cells containing the lost blocks.

29. A processing device for generating an irregular grid of cells, each cell having associated with it a separate motion vector based on the motion in a frame I(t−1) of a video bitstream, the processing device comprising:
means for reading a plurality of blocks of the frame I(t−1);
means for determining a complexity value representing the complexity of motion within each block of the frame I(t−1);
means for grouping blocks together that have a low complexity value into a large cell with a single motion vector representing motion within the large cell, and for grouping or dividing blocks that have a high complexity value into small cells, each small cell having a motion vector representing the motion within each small cell; and
means for generating an irregular grid made up of the large and/or small cells.

30. A processing device according to claim 29, wherein the large cell motion vector is an average of motion vectors of the grouped-together blocks.

31. A processing device according to claim 29, wherein the large cell motion vector is selected as the motion vector with the largest variance in horizontal and vertical directions from all the motion vectors of blocks within the area of the large cell.

32. An encoding method of encoding a first frame I(t) of a video bitstream, the method comprising:
generating an irregular grid of cells, each cell having associated with it a separate motion vector based on the motion of a second frame I(t−1) of the video bitstream at the position of the respective cell;
generating motion vectors to be applied to each cell of the irregular grid, the generated motion vectors representing the motion of the first frame I(t) of the video bitstream at positions corresponding to the positions of each cell when the irregular grid is applied to the first frame I(t); and
transmitting the generated motion vectors to a decoder.

33. A decoding method of decoding a first frame I(t) of a video bitstream, the method comprising, when a portion of the first frame I(t) is not correctly received:
generating an irregular grid of cells, each cell having associated with it a motion vector based on the motion of a second frame I(t−1) of the video bitstream at the position of the respective cell;
receiving motion vectors from an encoder to be applied to each cell of the irregular grid, the generated motion vectors representing motion in the first frame I(t) at positions corresponding to positions of the cells of the irregular grid when applied to the first frame I(t); and
applying the received motion vectors to the cells of the generated irregular grid at a position corresponding to the incorrectly-received portion of the first frame to generate a motion vector field to be used for motion prediction of the first frame I(t).
